(19) United States
(12) Patent Application Publication
(10) Pub. No.: US 2015/0081800 A1
(43) Pub. Date: Mar. 19, 2015

(54) MANAGING MEMBERSHIP IN SOCIAL GROUPINGS OF CONTACTS FOR A PARTICIPANT OF AN E-MAIL CONVERSATION THREAD

(71) Applicants: Steven Henry Bills, Mountain View, CA (US); Zohair Hyder, San Mateo, CA (US); Griffith Buckley Hazen, San Francisco, CA (US); Thompson Alexander Ivor Gawley, Palo Alto, CA (US); Jason Cornwell, San Francisco, CA (US); Matthew Frederick Hillman, Seattle, WA (US); Bella Kazwell, Menlo Park, CA (US)

(72) Inventors: Steven Henry Bills, Mountain View, CA (US); Zohair Hyder, San Mateo, CA (US); Griffith Buckley Hazen, San Francisco, CA (US); Thompson Alexander Ivor Gawley, Palo Alto, CA (US); Jason Cornwell, San Francisco, CA (US); Matthew Frederick Hillman, Seattle, WA (US); Bella Kazwell, Menlo Park, CA (US)

(73) Assignee: Google Inc., Mountain View, CA (US)

(21) Appl. No.: 13/475,738

(22) Filed: May 18, 2012

Related U.S. Application Data
(60) Provisional application No. 61/567,615, filed on Dec. 6, 2011.

(51) Int. Cl. G06F 15/16

(52) U.S. Cl. 709/206

(57) ABSTRACT

Configurations of the subject technology integrate with an online social networking service in order to manage membership of contacts within one or more social circles provided by the online social networking service. In one example, a button or other similar graphical element is provided to provide this functionality in a widget displayed in a user's e-mail application. The widget in one example is displayed in a conversation thread view of a conversation including one or more different e-mails from one or more participants. For a selected participant of the conversation thread, the aforementioned button is initially rendered to provide an indication of the participant's inclusion in one or more of the user's social circles. Selecting or hovering over the aforementioned button further allows the user to add the conversation participant to the user's social circles.

### CROSS-REFERENCE TO RELATED APPLICATIONS

The present application claims the benefit of priority under 35 U.S.C. §119 from U.S. Provisional Patent Application Ser. No. 61/567,615 entitled “MANAGING MEMBERSHIP IN SOCIAL GROUPINGS OF CONTACTS FOR A PARTICIPANT OF AN E-MAIL CONVERSATION THREAD,” filed on Dec. 6, 2011, the disclosure of which is hereby incorporated by reference in its entirety for all purposes.

### BACKGROUND

An e-mail application can display one or more e-mails in a user's inbox.

### SUMMARY

The subject technology provides an indication of one or more social circles for one or more participants of a conversation thread including one or more electronic messages. User input is received for selecting a participant of the conversation thread. The subject technology receives contact data of the participant responsive to the received user input in which the contact data includes a respective e-mail address associated with the participant in the conversation thread. One or more social circles are then determined that are associated with the respective e-mail address. The subject technology provides for display the contact data of the participant and an indication of the determined one or more social circles.

Yet another aspect of the subject technology provides a system for managing one or more social circles for one or more participants of a conversation thread. The system includes memory, one or more processors and one or more modules stored in memory and configured for execution by the one or more processors. The system includes an e-mail module configured to receive user input for selecting a participant of the conversation thread, receive contact data of the participant responsive to the received user input in which the contact data includes a respective e-mail address associated with the participant of the conversation thread. The system further includes a social networking module configured to determine if the respective e-mail address among the one or more e-mail addresses is associated with an online social networking profile, determine one or more social circles associated with the respective e-mail address if the respective e-mail address is associated with the online social networking profile. Additionally, the system includes a GUI display module configured to provide for display the contact data of the participant and an indication of the determined one or more social circles if the respective e-mail is associated with the online social networking profile.

The subject technology further provides for receiving user input for selecting a participant of the conversation thread. Contact data of the participant is received responsive to the received user input in which the contact data includes a respective e-mail address associated with the participant in the conversation thread. The subject technology determines if the respective e-mail address is associated with an online social networking profile. One or more social circles associated with the respective e-mail address are then determined if the respective e-mail address is associated with the online social networking profile. The subject technology provides for display the contact data of the participant and an indication of the determined one or more social circles if the respective e-mail is associated with the online social networking profile. Additionally, the subject technology provides for display the contact data of the participant and an indication of the participant being absent from social circles if the respective e-mail address is not associated with one or more social circles.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The novel features of the subject technology are set forth in the appended claims. However, for purpose of explanation, several configurations of the subject technology are set forth in the following figures.

FIG. 1 conceptually illustrates an example process for providing an indication one or more social circles for a selected participant of a conversation thread including one or more electronic messages.

FIG. 2 conceptually illustrates an example process for utilizing e-mail addresses for a participant of a conversation thread in order to determine one or more social circles including the participant.

FIG. 3A conceptually illustrates an example graphical user interface (GUI) of some configurations of the subject technology.

FIG. 3B conceptually illustrates an example graphical user interface (GUI) of some configurations of the subject technology.

FIG. 4 conceptually illustrates an example computing environment.

FIG. 5 conceptually illustrates a system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

An e-mail application can provide a web-based interface to enable a user to interact with the application. In some configurations, the e-mail application can include other communication functionality such instant messaging (IM), short message service (SMS) and/or video conferencing, etc. The e-mail application can organize electronic messages into one or more different conversation threads in which each conversation thread can include one or more different electronic messages (e.g., an initial message and subsequent reply messages) between one or more participants. As used herein, electronic messages can include, but not limited to, e-mails, SMS, instant messages, text messages, etc. Other types of electronic messages can be provided and still be within the scope of the subject technology.

The subject technology provides a widget that displays contextual information about the conversation's participants or a selected participant of the conversation thread. As used herein, the term “widget” refers to a lightweight application (e.g., lightweight in comparison to a full application suite or software package) providing a GUI that includes one or more graphical elements used to provide a specific application or functionality. Although the subject technology is described with reference to a widget, it should be noted that the subject technology can be used in conjunction with other types of applications.

For instance, the subject technology provides a single-person view for a selected participant (e.g., as selected from the widget from a list of participants) from the conversation thread. By way of example, the single-person view can display the participant's name, contact details, and picture. Additionally, the single-person view allows the user to initiate chat, call, calendar, and mail actions with the participant. The single-person view also provides data on recent e-mail communications between the participant and the user, shared documents, and the participant's calendar availability. In one aspect, the single-person view also includes the participant's data from online social networking services.

In a given social networking service, one or more contacts of a user can be organized in a social circle. In the context of the user's social graph, the social circle represents a grouping of one or more contacts from the user's social graph based on a level of trust or a type of relationship. For instance, the user can create a circle for friends and another circle for coworkers. The social networking service can then graphically represent the social circle with the grouping of contacts as a circle shape in which one or more graphical representations (e.g., avatars, profile pictures, icons, etc.) are included within the circle shape. In some configurations, other graphical representations can be utilized to represent the social circle.

As used herein, social circles (“circle” or “circles”) are categories to which a user can assign their social networking contacts and better control the distribution and visibility of social networking messages. For instance, a social circle can be provided as a data set defining a collection of contacts that are associated with one another. A social circle can be described from the perspective of an individual that is the center of a particular collection of socially interconnected people, or from the aggregate perspective of a collection of socially interconnected people. For example, a user may have different groups of friends, coworkers, and family, and there may be some overlap among those groups (e.g., a coworker who is also considered to be a friend, a family member who is also a coworker). Through the creation and use of social circles, the user can organize and categorize social networking contacts into various different groupings.

For extending the functionality of the widget, the subject technology can communicate with an online social networking service in order to manage membership of contacts within one or more social circles provided by the online social networking service. In one example, a button or other similar graphical element is included in the widget to provide this functionality. Hovering over or selecting this button allows the user to add an individual conversation participant to the user's social circles.

Some configurations of the subject technology utilizes an inline frame (or “iframe”) to insert the aforementioned button or graphical element into the widget. Another implementation integrates the social networking functionality as a native component of the widget. In some configurations, the button (or similar graphical element) is provided in other parts of the e-mail application and is still within the scope of the subject technology.

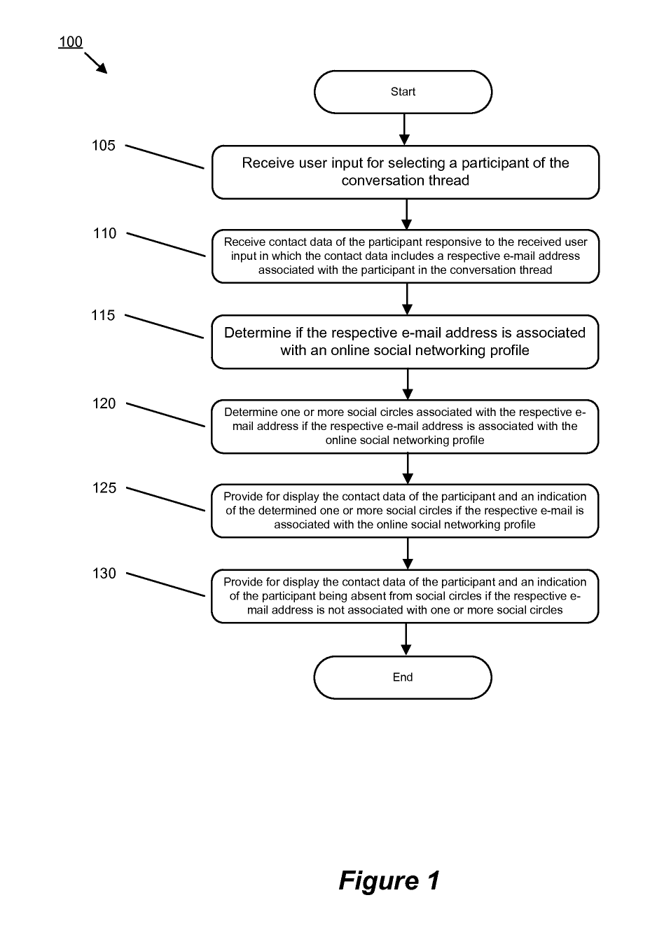

FIG. 1 conceptually illustrates an example process 100 for providing an indication one or more social circles for a selected participant of a conversation thread including one or more electronic messages. The conversation thread includes one or more e-mail messages. The process 100 is performed by one or more computing devices or systems in some configurations. For instance, a web e-mail application can perform the operations in the process 100 described in further detail below in order to manage and determine one or more social circles that include a participant of the conversation thread.

The process 100 begins at 105 by receiving user input for selecting a participant of the conversation thread. In one example, the selection of the participant can include user input such as, but not limited to, a mouse cursor selection, a keyboard shortcut selection, a touch input selection (e.g., via a touchscreen device), etc. Other types of user input can be received for selecting the participant and still be within the scope of the subject technology. As described above, the process 100 receives user input that activates a single-person view of the widget in one example. Further, the user input is received in a conversation thread view of the conversation thread of the e-mail application in one example.

The process 100 at 110 receives contact data of the participant responsive to the received user input. In one example, the contact data includes one or more e-mail addresses associated with the participant including at least a respective e-mail associated with the participant in the conversation thread. Further, the contact data includes at least one of a name corresponding to the participant, an occupation of the participant, and a phone number of the participant in some configurations. The contact data in some implementations is stored in a contact data store either remotely and/or locally.

The process 100 at 115 determines if the participant's respective e-mail address is associated with an online social networking profile. The respective e-mail address is the corresponding e-mail address that it displayed in the widget or e-mail application in some configurations. The social networking profile is associated with at least one e-mail address of the participant as provided in the contact data in some configurations. By way of example, the process 100 can submit a query or request to the online social networking service to determine whether any e-mail address is associated to an existing online social networking profile.

The process 100 at 120 identifies one or more social circles associated with the respective e-mail address if the respective e-mail address is associated with the online social networking profile. In one example, determining one or more social circles associated with the respective e-mail address is accomplished by requesting or querying membership data of the one or more social circles. For instance, the membership data includes one or more e-mail addresses respectively associated with the one or more social circles. In some configurations, the membership data is provided by the online social networking service.

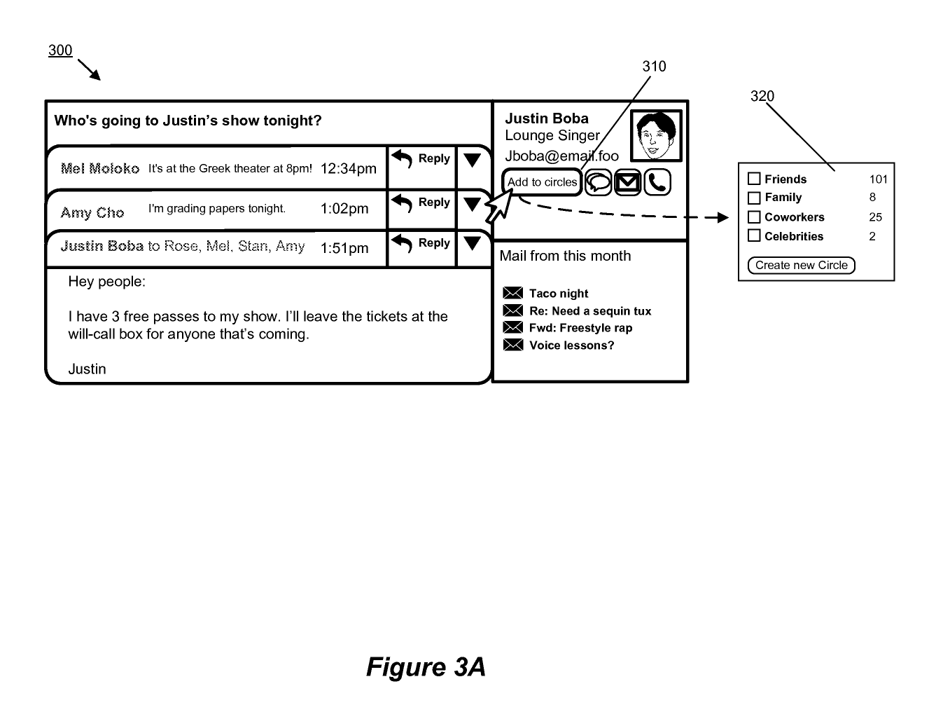

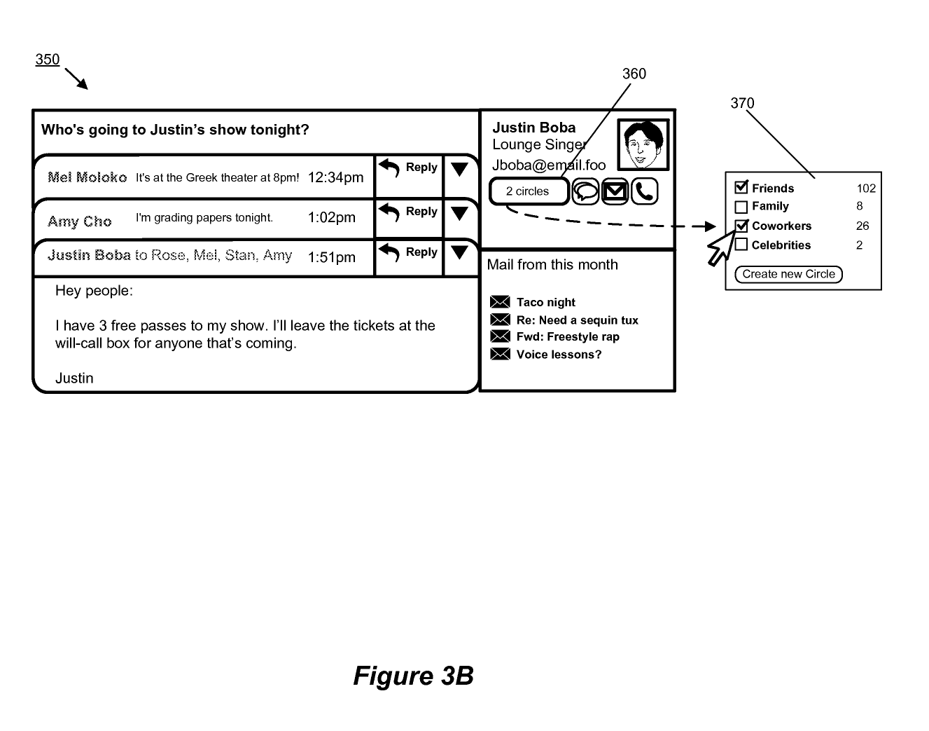

The process 100 at 125 provides for display the contact data of the participant and an indication of the determined one or more social circles if the respective e-mail is associated with the online social networking profile. In some configurations, the indication is a graphical element displaying a status of the participant's inclusion in one or more social circles. An example graphical user interface (GUI) for displaying the contact data and the indication of the determined one or more social circles is described in further detail below in FIGS. 3A and 3B.

The process 100 at 130 provides for display the contact data of the participant and an indication of the participant being absent from social circles if the respective e-mail address is not associated with one or more social circles. In one example, the participant's e-mail address, although associated with an online social networking profile, is not included in any of the user's social circles. The process 100 provides an indication of such in these instances. The process 100 then ends.

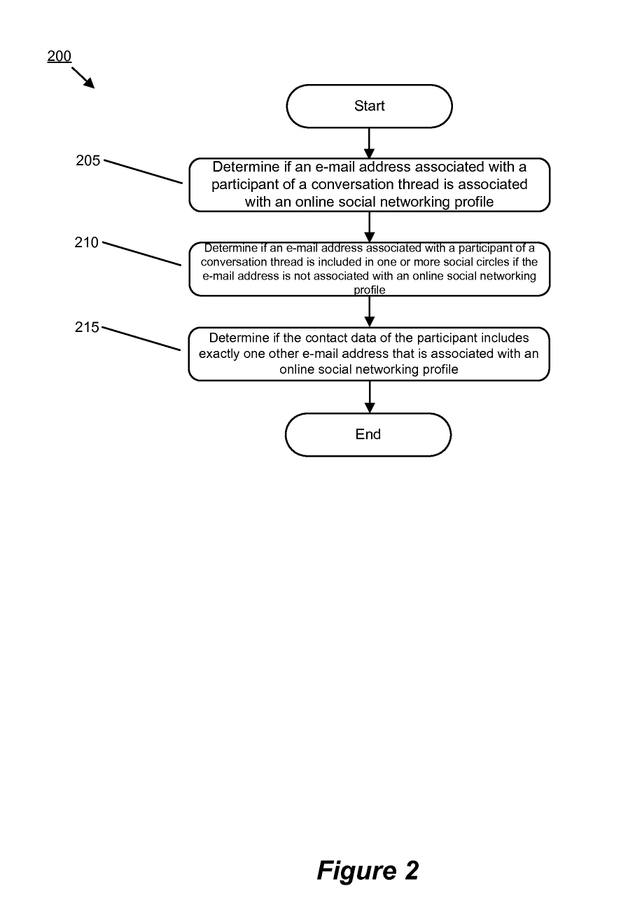

FIG. 2 conceptually illustrates an example process 200 for utilizing e-mail addresses for a participant of a conversation thread in order to determine one or more social circles including the participant. In some configurations, the process 200 can be performed by one or more computing devices or systems in conjunction with the process 100 (e.g., at 120) described in FIG. 1 in order to determine the participant's inclusion in one or more social circles based on the participant's e-mail address(es).

The process 200 begins at 205 by determining if an e-mail address associated with a participant of a conversation thread is associated with an online social networking profile. The operation performed at 210 is similar to that described in FIG. 1 at 115. If the process 200 determines that the participant's e-mail address is associated with an online social networking profile, one or more social circles (that include the participant) can be determined based on that e-mail address by the process 200. Referring back to FIG. 1, the process 100 can provide for display at 125 the contact data of the participant and an indication of the determined one or more social circles. Alternatively, if the participant's e-mail address is not associated with an online social networking profile, the process 200 continues to 210.

At 210, in the event that no social networking profile is associated with the e-mail address, the process 200 determines if the e-mail address associated with the participant in the conversation thread is included in one or more social circles. In some instances, the participant's associated e-mail address is not associated with an online social networking profile but has been added in one or more of the user's social circles. The process 200 identifies one or more social circles based on this determination at 210. Referring back to FIG. 1, the process 100 can further provide for display at 125 the contact data of the participant and an indication of the determined one or more social circles if the e-mail address is included in one or more social circles.

In the event that the process 200 does not determine that the participant's e-mail address is included in any social circles, the process 200 at 215 then determines if the contact data of the participant includes exactly one other e-mail address that is associated with an online social networking profile. In some instances, the participant's contact data can include an additional e-mail address(es). Based on the determination at 215, the process 200 identifies the one or more social circles associated with that e-mail address if exactly one other e-mail address is associated with an online social networking profile. Referring back to FIG. 1, the process 100 can further provide for display at 125 the contact data of the participant and an indication of the determined one or more social circles associated with the exactly one other e-mail address associated with the online social networking profile. The process 200 then ends.

FIG. 3A conceptually illustrates a graphical user interface (GUI) 300 in which some configurations of the subject technology can be implemented. More specifically, the GUI 300 can include different sets of graphical elements for displaying a conversation thread participant's inclusion in one or more social circles as described by reference to the respective processes described in FIGS. 1 and 2. A graphical element can include, but is not limited to, a button, check box, radio button, slider, list box, drop-down list, menu, combo box, icon, text box, scroll bar, etc. In one example, the GUI 300 is displayed in the user's e-mail application.

As illustrated in FIG. 3A, the GUI 300 includes a conversation thread view of a conversation including one or more different e-mails. The GUI 300 includes a graphical element 310 (e.g., button) that is initially rendered to provide an indication of a participant's inclusion in one or more social circles based on an associated e-mail address of the participant (e.g., as described in FIGS. 1 and 2). In the example GUI shown in FIG. 3A, the graphical element 310 is shown with an indication that the participant is absent or not included in any social circles (as shown by the “Add to circles” text).

The user can select the graphical element 310 in order to present a pop-up window or context menu 320 displaying a listing of one or more social circles. For instance, the user can perform a mouse-over input over the graphical element 310 in order to display the context menu 320. In the example shown in FIG. 3A, the context menu 320 includes the listing of one or more social circles. As described before, each social circle includes one or more contacts based on a relationship type and/or other criteria. For instance, the example GUI 300 includes respective social circles for friends, family, coworkers, and celebrities. Each social circle also includes a corresponding checkbox graphical element that enables the user to select for including the participant in the corresponding social circle. The context menu 320 also includes a graphical element for creating a new social circle. Other graphical elements can be provided in the context menu 320 and still be within the scope of the subject technology.

FIG. 3B conceptually illustrates a graphical user interface (GUI) 350 in which some configurations of the subject technology can be implemented. The example GUI 350 shown in FIG. 3B is similar to the GUI 300 described above in FIG. 3A.

As illustrated in FIG. 3B, the GUI 350 includes a conversation thread view of a conversation including one or more different e-mails. The GUI 350 includes a graphical element 360 (e.g., button) that is rendered to provide an indication of a participant's inclusion in one or more social circles based on an associated e-mail address of the participant (e.g., as described in FIGS. 1 and 2). In the example GUI 350 shown in FIG. 3B, the graphical element 360 is shown with an indication that the participant is included in two social circles (as shown by the “2 circles” text).

As further shown in FIG. 3B, a context menu 370 is included in the GUI 350 that includes a listing of social circles. The context menu 370 includes a corresponding checkbox graphical element for each social circle that enables the user to select for including the participant in the corresponding social circle. In the example of FIG. 3B, the respective checkboxes for the friends and coworkers social circles are selected by the user (as indicated by the checked checkbox graphical elements). Responsive to the selected social circles, the subject technology updates membership data for the selected social circle(s) for including the participant in which the membership data includes one or more e-mail addresses of different contacts. Similarly, the user can provide input for de-selecting at least one of the one or more social circles as provided in the listing shown in the context menu 370. The subject technology then updates the membership data for the de-selected social circle(s) for removing the participant. Based on the selection and/or de-selection of one or more social circles, the GUI 350 provides for display an indication of the determined one or more social circles based on the updated membership data. For example, the GUI 350 can display the graphical element 360 to indicate that the participant is now included in two different social circles based on the selection of the friends and coworkers social circles in the context menu 370.

Although the example GUI 300 and 350 in FIGS. 3A and 3B includes four different social circles, any number of social circle can be included in the GUIs 300 and 350 and still be within the scope of the subject technology. Additionally, although the above description of FIGS. 3A and 3B includes different example graphical elements in the GUIs 300 and 350, some implementations can include other graphical elements in the GUIs 300 and 350 and still be within the scope of the subject technology. Further, the GUIs 300 and 350 are not required to include all of the aforementioned graphical elements.

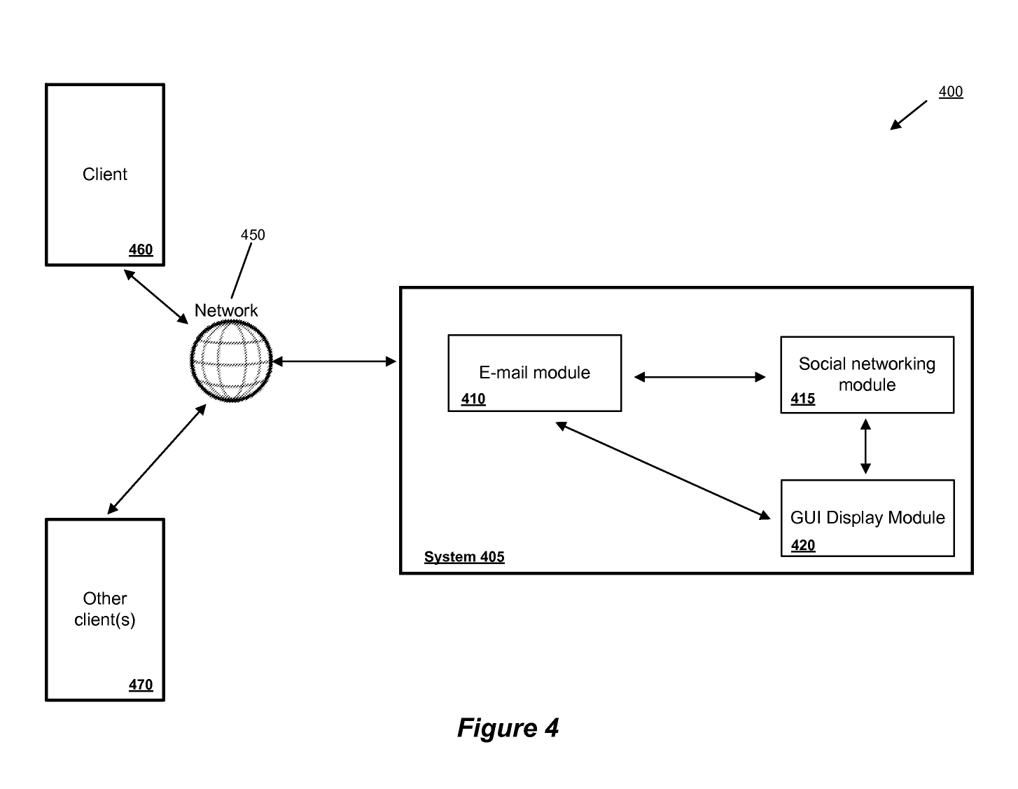

FIG. 4 conceptually illustrates an example computing environment 400 including a system. In particular, FIG. 4 shows a system 405 for implementing the above described processes in FIGS. 1 and 2 and for providing the GUIs illustrated in FIGS. 3A and 3B. In some configurations, the system 405 is part of an implementation running a particular machine (e.g., a server).

The system 405 can include memory, one or more processors, and one or more modules stored in memory and configured for execution by the one or more processors. As shown in FIG. 4, the system 405 includes several modules for providing different functionality. The system 405 is configured to include an e-mail module 410, a social networking module 415, and a GUI display module 420. The e-mail module 410 is configured to receive user input for selecting a participant of the conversation thread, and receive contact data of the participant responsive to the received user input in which the contact data includes a respective e-mail address associated with the participant in the conversation thread. The social networking module 415 is configured to determine if a respective e-mail address among the one or more e-mail addresses is associated with an online social networking profile, and determine one or more social circles associated with the respective e-mail address if the respective e-mail address is associated with the online social networking profile. The GUI display module 420 is configured to provide for display the contact data of the participant and an indication of the determined one or more social circles if the respective e-mail is associated with the online social networking profile.

As further shown in FIG. 4, each of the aforementioned modules can be configured to communicate between each other. For instance, different data, messages, API calls and returns can be passed between the different modules in the system 405.

The system 405 can communicate over a network 450 with a client 460. The client 460 can each be configured to communicate with the aforementioned modules of the system 405. For instance, the client 460 can transmit a request for providing a conversation thread participant's data related to one or more social circles over the network 450 to the system 405. The system 405 can then transmit data for displaying an indication of the participant's inclusion in one or more social circles over the network 450 to the client 460. As further shown in FIG. 4, other client(s) 470 can communicate over the network 450 with the system 405 in a similar manner.

Many of the above-described features and applications are implemented as software processes that are specified as a set of instructions recorded on a machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of machine readable media include, but are not limited to, CD-ROMs, flash drives, RAM chips, hard drives, EPROMs, etc. The machine readable media does not include carrier waves and electronic signals passing wirelessly or over wired connections.

In this specification, the term “software” is meant to include firmware residing in read-only memory and/or applications stored in magnetic storage, which can be read into memory for processing by a processor. Also, in some implementations, multiple software components can be implemented as sub-parts of a larger program while remaining distinct software components. In some implementations, multiple software subject components can also be implemented as separate programs. Finally, any combination of separate programs that together implement a software component(s) described here is within the scope of the subject technology. In some implementations, the software programs, when installed to operate on one or more systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some configurations are implemented as software processes that include one or more application programming interfaces (APIs) in an environment with calling program code interacting with other program code being called through the one or more interfaces. Various function calls, messages or other types of invocations, which can include various kinds of parameters, can be transferred via the APIs between the calling program and the code being called. In addition, an API can provide the calling program code the ability to use data types or classes defined in the API and implemented in the called program code.

The following description describes an example system in which aspects of the subject technology can be implemented.

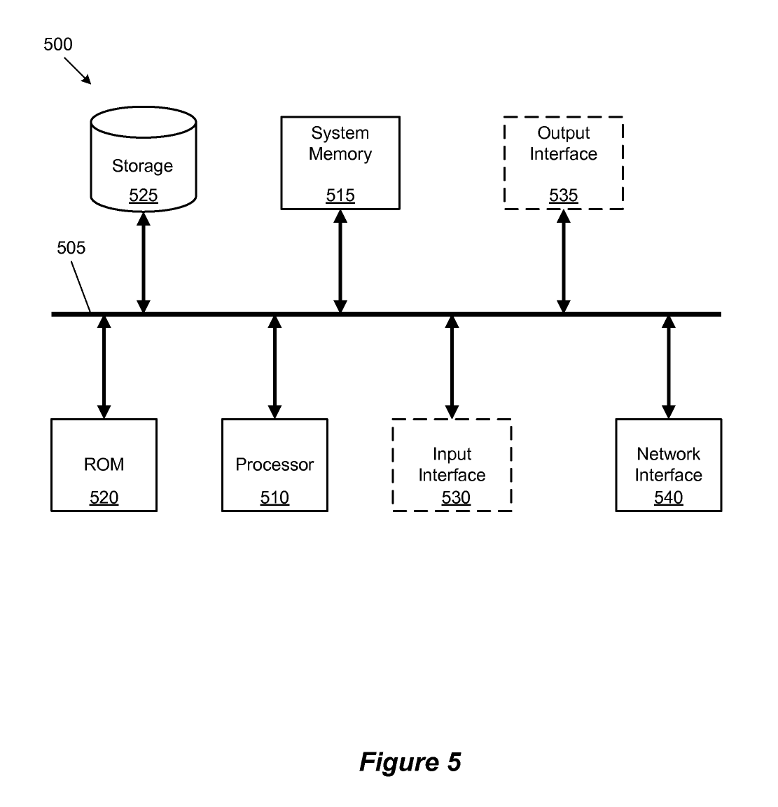

FIG. 5 conceptually illustrates a system 500 with which some implementations of the subject technology can be implemented. The system 500 can be a computer, phone, PDA, or any other sort of electronic device. In some configurations, the system 500 includes a television with one or more processors embedded therein. Such a system includes various types of computer readable media and interfaces for various other types of computer readable media. The system 500 includes a bus 505, processing unit(s) 510, a system memory 515, a read-only memory 520, a storage device 525, an optional input interface 530, an optional output interface 535, and a network interface 540.

The bus 505 collectively represents all system, peripheral, and chipset buses that communicatively connect the numerous internal devices of the system 500. For instance, the bus 505 communicatively connects the processing unit(s) 510 with the read-only memory 520, the system memory 515, and the storage device 525.

From these various memory units, the processing unit(s) 510 retrieves instructions to execute and data to process in order to execute the processes of the subject technology. The processing unit(s) can be a single processor or a multi-core processor in different implementations.

The read-only-memory (ROM) 520 stores static data and instructions that are needed by the processing unit(s) 510 and other modules of the system 500. The storage device 525, on the other hand, is a read-and-write memory device. This device is a non-volatile memory unit that stores instructions and data even when the system 500 is off. Some implementations of the subject technology use a mass-storage device (such as a magnetic or optical disk and its corresponding disk drive) as the storage device 525.

Other implementations use a removable storage device (such as a flash drive, a floppy disk, and its corresponding disk drive) as the storage device 525. Like the storage device 525, the system memory 515 is a read-and-write memory device. However, unlike storage device 525, the system memory 515 is a volatile read-and-write memory, such a random access memory. The system memory 515 stores some of the instructions and data that the processor needs at runtime. In some implementations, the subject technology's processes are stored in the system memory 515, the storage device 525, and/or the read-only memory 520. For example, the various memory units include instructions for processing multimedia items in accordance with some implementations. From these various memory units, the processing unit(s) 510 retrieves instructions to execute and data to process in order to execute the processes of some implementations.

The bus 505 also connects to the optional input and output interfaces 530 and 535. The optional input interface 530 enables the user to communicate information and select commands to the system. The optional input interface 530 can interface with alphanumeric keyboards and pointing devices (also called “cursor control devices”). The optional output interface 535 can provide display images generated by the system 500. The optional output interface 535 can interface with printers and display devices, such as cathode ray tubes (CRT) or liquid crystal displays (LCD). Some implementations can interface with devices such as a touchscreen that functions as both input and output devices.

Finally, as shown in FIG. 5, bus 505 also couples system 500 to a network interface 540 through a network adapter (not shown). In this manner, the computer can be a part of a network of computers (such as a local area network (“LAN”), a wide area network (“WAN”), or an Intranet, or an interconnected network of networks, such as the Internet. Any or all components of system 500 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A machine-implemented method for providing an indication of one or more social circles for a selected participant of a conversation thread including one or more electronic messages, the method comprising:
receiving input from a user for selecting a participant of the conversation thread;
receiving contact data of the participant responsive to the received input, wherein the contact data includes a respective e-mail address associated with the participant in the conversation thread;
determining whether one or more social circles of the user in a social network are associated with the respective e-mail address;
providing for display the contact data of the participant and one or more indications of whether the respective e-mail address is associated with the one or more social circles of the user in the social network; and
toggling association of the respective e-mail address with the one or more social circles of the user in the social network in response to a selection of the one or more indications.

2. The method of claim 1 further comprising:
if the respective e-mail address is not associated with an online social networking profile, determining if the respective e-mail address is included in one or more social circles; and
providing for display the contact data of the participant and an indication of the determined one or more social circles if the respective e-mail address is included in one or more social circles.

3. The method of claim 2, further comprising:
determining if the contact data of the participant includes exactly one other e-mail address that is associated with an online social networking profile;
determining the one or more social circles associated with the exactly one other e-mail address if the exactly one other e-mail address is associated with the online social networking profile; and
providing for display the contact data of the participant and an indication of the determined one or more social circles associated with the exactly one other e-mail address.

4. The method of claim 1, further comprising:
providing for display the contact data of the participant and an indication of the participant being absent from social circles if the respective e-mail address is not associated with one or more social circles.

5. The method of claim 1, further comprising:
providing for display a listing of the one or more social circles;
receiving user input selecting at least one of the one or more social circles; and
updating membership data for the selected at least one social circle for including the participant, wherein the membership data includes one or more e-mail addresses of different contacts.

6. The method of claim 5, further comprising:
receiving user input de-selecting at least one of the one or more social circles; and
updating the membership data for the de-selected at least one social circle for removing the participant.

7. The method of claim 6, further comprising:
provide for display the indication of the determined one or more social circles based on the updated membership data.

8. The method of claim 1, wherein the contact data further includes at least one of a name corresponding to the participant, an occupation of the participant, and a phone number of the participant.

9. The method of claim 1, wherein the conversation thread includes one or more e-mail messages.

10. The method of claim 1, wherein the indication is a graphical element displaying a status of the participant's inclusion in one or more social circles.

11. The method of claim 1, wherein determining one or more social circles associated with the respective e-mail address comprises requesting membership data of the one or more social circles.

12. The method of claim 11, wherein the membership data includes one or more e-mail addresses respectively associated with the one or more social circles.

13. The method of claim 1, wherein receiving user input for selecting the participant of the conversation thread occurs in a conversation thread view of the conversation thread.

14. A system for managing one or more social circles for one or more participants of a conversation thread:
memory;
one or more processors;
one or more modules stored in memory and configured for execution by the one or more processors, the modules comprising:
an e-mail module configured to receive user input from a user for selecting a participant of the conversation thread, and retrieve contact data of the participant responsive to the received user input, wherein the contact data includes one or more e-mail addresses associated with the participant;
a social networking module configured to determine if a respective e-mail address among the one or more e-mail addresses is associated with an online social networking profile of a social network, and determine a number of the social circles of the user in the social network that are associated with the respective e-mail address if the respective e-mail address is associated with the online social networking profile; and
a GUI display module configured to provide for display the contact data of the participant and an indication of the number of the social circles of the user in the social network that are associated with the respective e-mail address if the respective e-mail is associated with the online social networking profile.

15. The system of claim 14, wherein the GUI display module is further configured to provide for display the contact data of the participant and an indication of the participant being absent from social circles if the respective e-mail address is not associated with one or more social circles.

16. The system of claim 14, wherein the social networking module is further configured to:
if the respective e-mail address is not associated with an online social networking profile, determine if the respective e-mail address is included in one or more social circles.

17. The system of claim 16, wherein the social networking module is further configured to:
determine if the contact data of the participant includes exactly one other e-mail address that is associated with a social networking profile; and
determine the one or more social circles associated with the exactly one other e-mail address if the exactly one other e-mail address is associated with the social networking profile.

18. The system of claim 14, wherein the GUI display module is further configured to:
provide for display a listing of the one or more social circles; and
receive user input selecting at least one of the one or more social circles.

19. The system of claim 18, wherein the social networking module is further configured to:
update membership data for the selected at least one social circle for including the participant, wherein the membership data includes one or more e-mail addresses of different contacts.

20. The system of claim 19, wherein the GUI display module is further configured to:
receive user input de-selecting at least one of the one or more social circles.

21. The system of claim 20, wherein the social networking module is further configured to:
update the membership data for the de-selected at least one social circle for removing the participant.

22. The system of claim 21, wherein the GUI display module is further configured to:
provide for display the indication of the determined one or more social circles based on the updated membership data.

23. A machine-readable medium comprising instructions stored therein, which when executed by a machine, cause the machine to perform operations comprising:
receiving input from a user for selecting a participant of a conversation thread;
receiving contact data of the participant responsive to the received input, wherein the contact data includes a respective e-mail address associated with the participant in the conversation thread;
determining if the respective e-mail address is associated with an online social networking profile in a social network;
determining whether the respective e-mail address is associated with groups of contacts of the user in the social network if the respective e-mail address is associated with the online social networking profile;
providing for display the contact data of the participant and indications of whether the respective e-mail address is associated with the groups of contacts of the user in the social network, respectively, if the respective e-mail is associated with the online social networking profile; and
providing for display the contact data of the participant and another indication of the participant being absent from the groups of contacts of the user in the social network if the respective e-mail address is not associated with the online social networking profile.
